(19) United States
(12) Patent Application Publication
(10) Pub. No.: US 2026/0361765 A1
(43) Pub. Date: Nov. 12, 2026

(54) ELEPHANT FLOW DETECTION AND MITIGATION

(71) Applicant: NetScout Systems, Inc., Westford, MA (US)

(72) Inventors: Jamie Winquist, Ypsilanti, MI (US); Matt Bregger, Westford, MA (US); Rob Skrobola, Saline, MI (US); Stephen Siadak, Ann Arbor, MI (US)

(73) Assignee: NetScout Systems, Inc., Westford, MA (US)

(21) Appl. No.: 19/201,536

(22) Filed: May 7, 2025

(51) Int. Cl. H04L 9/40

(52) U.S. Cl. CPC H04L 63/1458; H04L 63/0236; H04L 63/1425

(57) ABSTRACT

Systems, methods, and programming for detecting and mitigating network resource consumption elephant flows in distributed network resources. In some examples, a tuple including at least: (i) a source internet protocol (IP) address, (ii) a destination IP address, (iii) a source port number, (iv) a destination port number, and (v) a transport protocol of a data packet may be identified within data. Based on the identified tuple, a determination can be made as to whether an abnormal data traffic condition has been satisfied. If so, an announcement may be generated for one or more network monitoring devices. The announcement may include the tuple and one or more network resource usage modification rules to be applied by the network monitoring devices to data packets received subsequent to the announcement, where the announcement may be transmitted to at least some of the network monitoring devices.

### BACKGROUND

While both elephant flows and Distributed Denial of Service (DDOS) attacks involve large volumes of data traffic, they serve different purposes. DDOS attacks are malicious and aim to disrupt network services, whereas elephant flows, despite their size, may not be intended to cause harm.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for detecting and mitigating network resource consumption elephant flows, in accordance with an implementation;

FIG. 2 is an illustration of an example data packet, in accordance with an implementation;

FIG. 3 is an illustration of an example graphical user interface describing data flows of a set of tuples, in accordance with an implementation;

FIG. 4 is an illustration of a flow diagram of an example process for detecting and mitigation network resource consumption elephant flows, in accordance with an implementation;

FIG. 5A is a block diagram depicting an implementation of a network environment including a client device in communication with a server device, in accordance with an implementation;

FIG. 5B is a block diagram depicting a cloud computing environment including a client device in communication with cloud service providers, in accordance with an implementation; and

FIG. 6 is a block diagram depicting an implementation of a computing system that can be used in connection with the system depicted in FIG. 1 and the process depicted in FIG. 4.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

An elephant flow refers to large, long-lived data flows that consume a significant portion of network resources. Elephant flows can be characterized by high bandwidth consumption, extended duration of the high bandwidth consumption, predictable patterns, as well as other aspects. Elephant flows are different from DDoS attacks despite both involving large volumes of data being transmitted across a network. For example, DDoS attacks are most-often malicious in intent, with a goal of disrupting network resource availability. Elephant flows, on the other hand, may not necessarily be nefarious. However, like DDoS attacks, if not addressed, elephant flows can significantly impact network resource availability for a computing network. For example, in addition to reducing access to network resource, unmitigated elephant flows can reduce a network's ability to fend off other malicious attacks.

Network data traffic includes data packets transmitted between devices, each containing a set of facets. A facet represents a characteristic of the data packet, such as the source IP address, destination IP address, source port number, destination port number, protocol, transport protocol, source and destination information, Autonomous System Number (ASN), and temporal information (e.g., timestamps).

A tuple is a sequence of elements that uniquely identify a network connection. For example, a 5-tuple in TCP/IP networking includes the source IP address, source port number, destination IP address, destination port number, and transport protocol. Tuples are used to track and manage network connections. In contrast, facets are descriptive attributes of a data packet used in data analysis to filter and categorize packets. In some embodiments, a tuple may be created based on a set of facets, representing the extracted values of the facets.

Described herein are systems, methods, and programming for detecting and mitigating elephant flows in network data traffic. In some embodiments, a particular set of facets associated with a data packet may be identified from data traffic detected by, and received from, one or more network monitoring devices (e.g., network routers, switches, etc.). For example, the set of facets may include the source IP address, the destination IP address, the source port number, the destination port number, and the transport protocol. A tuple can be created using the set of facets, and an alert can be created to monitor network traffic instances of the tuple. For example, each data packet received by a network monitoring device matching the alert's values (e.g.,, a tuple created based on the facets of the data packet matches the tuple associated with the created alert) can be identified.

As more data packets or tuples for data packets are identified matching the alert's values, a determination can be made as to whether the data traffic flow for that tuple satisfies one or more abnormal data traffic conditions. The abnormal data traffic conditions may include a data flow condition, which may be satisfied when a data flow rate of the data traffic is greater than or equal to a data flow threshold (e.g., where the data traffic has a data flow rate of 1 or more GBps, 10 or more GBps, etc.). The abnormal data traffic conditions may include a packet quantity threshold condition, which may be satisfied when a number of data packets including the alert's values is greater than or equal to a data packet quantity threshold (e.g., 1 or more data packets matching a particular tuple, 10 or more data packets matching the tuple, etc.). The abnormal data traffic conditions may include other conditions as well, such as bot test conditions, data volume conditions, geographic conditions, and the like.

If it is determined that one or more of the abnormal data traffic conditions have been satisfied, an announcement (e.g., an announcement message, such as a flowspec mitigation announcement) may be generated. The announcement may include instructions to be provided to one or more of the network monitoring devices, computing devices coupled to the network monitoring devices or their corresponding networks, or other components. The announcement can include the tuple (e.g., source IP address, destination IP address, source port number, destination port number, transport protocol) that was compared against the abnormal data traffic conditions, as well as, in some embodiments, one or more network resource usage modification rules.

The network resource usage modification rules may be selected based on the abnormal data traffic condition or conditions that have been satisfied. For example, a network resource usage modification rule may include instructing network monitoring devices to redirect subsequently received data packets matching the alert's values (e.g., the tuple) to one or more computing devices, computing systems, and the like, instead of their intended destination. By doing so, the network resource usage modification rules solve the technical problems associated with elephant flows by enabling data packets matching the alert's values (e.g., the tuple) can be analyzed securely without risk of harming devices within the destination device's network. Furthermore, redirecting these data packets reduces data traffic and network resource consumption by diverting large volume traffic flow specific to the tuple to other network resources, thereby preventing data latency and data loss while increasing data security for other aspects of the remaining data traffic. In addition to redirecting data traffic, other examples of network resource usage modification rules can include instructing the network monitoring devices to limit a volume, frequency, quantity, or other parameter of data packets within the received data traffic matching the alert's values (e.g., the tuple), instructing the network monitoring devices to drop or otherwise block data packets matching the alert's values from passing into or out of those network monitoring devices, or others, or combinations thereof.

Another technical advantage of the described embodiments includes enabling dynamic state shifting of tuples based on real-time analysis of the data traffic. For instance, data packets detected by network monitoring devices can continually be analyzed (e.g., by the network monitoring device itself or by a computing system with which the monitoring device forwards the data packets, or data representing the data packets, for real-time analysis). The analysis can include determining whether any data packets have subsequently been received matching the alert's values. The abnormal data traffic conditions can be continually analyzed against the data packets matching the alert's values to determine whether (i) the data packets including the tuple continue to satisfy one or more of the abnormal data traffic conditions, (ii) the data packets including the tuple no longer satisfy one or more of the abnormal data traffic conditions (previously satisfied), (iii) the data packets including the tuple satisfy one or more other/new abnormal data traffic conditions, and the like. Depending on the abnormal data traffic conditions that are satisfied (or not satisfied), the network resource usage modification rules to be applied can remain the same, update to remove one or more of the network resource usage modification rules, update to add one or more network resource usage modification rules, or a combination thereof.

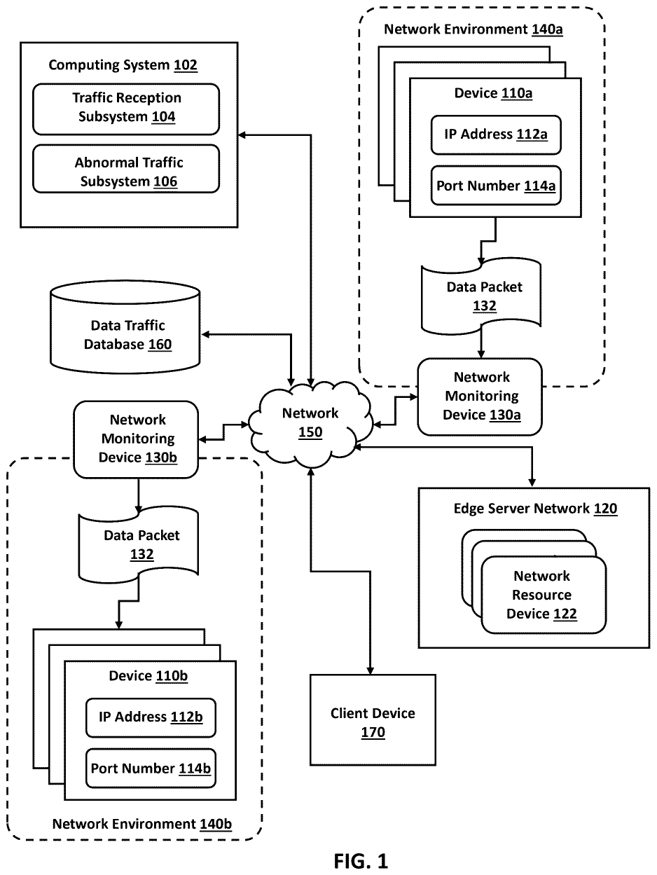

FIG. 1 is an illustration of an example system 100 for detecting and mitigating network resource consumption elephant flows, in accordance with an implementation. System 100 may include a computing system 102, an edge server network 120, one or more network monitoring devices 130a-130b (also referred to collectively as “monitoring devices 130”), a data traffic database 160, a client device 170, or other components. Each of the components of system 100 may communicate with one another, as well as other devices, systems, servers, etc., using a network 150 (e.g., the Internet).

Network monitoring devices 130 may be configured to monitor data traffic (i.e., data packets) inbound to a network environment of computing devices and/or outbound from the network environment of computing devices. Network monitoring devices 130 may, in some embodiments, sit on an edge of their corresponding network environment. For example, network monitoring device 130a may sit at an edge of a network environment 140a, whereas network monitoring device 130b may sit at an edge of a network environment 140b. In some embodiments, network monitoring devices 130 may include (either itself or as a component of) a router or switch used to connect network environments 140a, 140b to network 150. Network monitoring devices 130 may receive data packets (e.g., Internet protocol (IP) packets) flowing across network links connecting network environments 140a, 140b and network 150.

In some embodiments, network environment 140a may include devices 110a and network environment 140b may include devices 110b. Devices 110a may be the same or similar to devices 110b. For example, devices 110a, 110b may include client devices, such as personal computers, mobile computers, server stacks, etc. However, devices 110a and 110b may include different distributions of device types, different quantities of each device type, different quantities of devices in total, different associated permissions, different geographic information, or other differences, or other similarities. Each of devices 110a may include an IP address 112a that uniquely identify that device within network environment 140a. Similarly, each of devices 110b may include an IP address 112b that uniquely identify that device within network environment 140b. In some examples, IP addresses 112a, 112b may be IPv4 (e.g., XX.X.X) or IPv6 (e.g., X XX:XX:XX:X:XX:XX). Each of devices 110a may also include a port number 114a, and each of devices 110b may include a port number 114b. Depending on whether a device from devices 110a or devices 110b serves as a source device of a data packet, port numbers 114a, 114b may refer to a source port number or a destination portion number. For example, consider a source device from devices 110a of network environment 140a that outputs a data packet 132 directed to a destination device of devices 110b of network environment 140b. In this example, port number 114a may be referred to a source port number, which identifies an application used by the source device to send data packet 132, and port number 114b may refer to an application used by the destination device to receive data packet 132. Source port numbers may be selected from a range of ephemeral ports (e.g., 49152-65535). Destination ports may be selected from a known or defined port number associated with a particular service, such as HTTP which uses port 80 or HTTPS which uses port 443.

Data packet 132, which can also be referred to interchangeably as an IP packet, carries hyper-text transport protocol (HTTP) or HTTPS requests. HTTP/HTTPS requests include a string identifying a network resource being requested by a source device (i.e., a source of the HTTP/HTTPS request). Data packets are transmitted across network 150 using predefined network communication protocols. For example, these protocols, also referred to as transport protocols, are a set of rules specifying how data packets are transmitted across a network. Some example transport protocols include the Transmission Control Protocol (TCP), which may be used for web browsing (HTTP/HTTPS), email (SMTP), and file transfers (FTP), and the User Diagram Protocol (UDP), which may be used for real-time applications, streaming services, voice over IP (VOIP), etc. Another example is the Quick UDP Internet Connections (QUIC) transport protocol, which may be used for streamlining services.

Data packet 132 may include data indicating a source IP address of a source device that sent data packet 132. In the example of FIG. 1, data packet 132, which may be transmitted from a source device included by devices 110a of network environment 140a to a destination device included by devices 110b of network environment 140b. Data packet 132 may, in this example, be described using a set of facets. In some embodiments, the set of facets may include a source IP address of the source device, a destination IP address of the destination device, a source port number of the application used by the source device to send data packet 132, a destination port number of the application used by the destination device to receive data packet 132, and a transportation protocol of data packet 132.

In some embodiments, data packet 132 may be received by network monitoring device 130a prior to being output from network environment 140a. Network monitoring device 130a may be configured to provide data packet 132 to computing system 102 for various analyses and/or actions. In some examples, copies of the data packets may be provided to computing system 102 instead of the data packets. For example, a copy of data packet 132 may be provided to computing system 102 from network monitoring device 130a. Alternatively, or additionally, network monitoring device 130b may be configured to provide data packet 132 (or a copy of data packet 132) to computing system 102. In this sense, each of network environments 140a, 140b can serve as a destination or source of a data packet. In some embodiments, network monitoring devices 130a, 130b may provide the data packets to computing system 102 in real-time or in batches.

Computing system 102, while represented as a single system in FIG. 1, may be composed of one or multiple computing systems (e.g., a distributed server). Computing system 102 may include one or more subsystems, modules, devices, and the like, configured with computer program instructions stored in memory to execute operations. For example, computing system 102 may include a traffic reception subsystem 104, an abnormal traffic subsystem 106, or other components. In some embodiments, traffic reception subsystem 104 may be configured retrieve data traffic from network monitoring device 130a, 130b. The data traffic may be received in real-time or in batches. Furthermore, the data traffic received by traffic reception subsystem 104 may include the data packets from network resource devices 130a, 130b, or copies of those data packets.

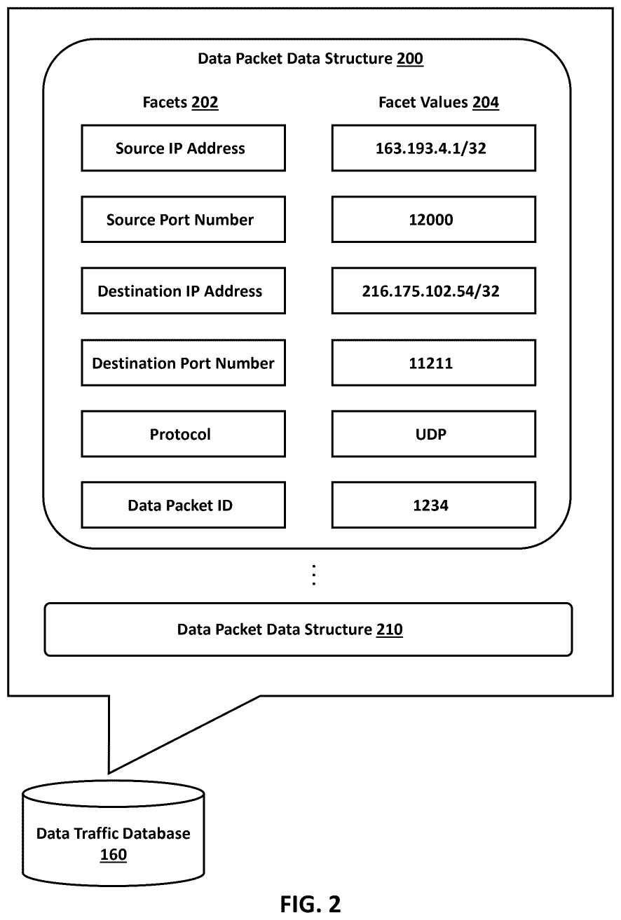

In some embodiments, traffic reception subsystem 104 may further be configured to generate tuples for each data packet. The tuples can be represented logically using data structures that store information about each data packet, such as facets that describe the data packet and the values extracted for those facets. The tuples can be used to perform analysis on whether any abnormal data traffic conditions are present. The data structure may include data fields corresponding to the facets, and these data fields may be populated with values extracted from the data packets for those facets. As an example, with reference to FIG. 2, tuple 200 may represent a data packet (e.g., data packet 132) transmitted from one network environment (e.g., network environment 140a) to another network environment (e.g., network environment 140b). Tuple 200 may include facet data fields 202 and facet values 204. For example, facet data fields 202 may include a data field associated with a source IP address of a source device of the data packet (e.g., IP address 112a of device 110a from network environment 140a), a data field associated with a destination IP address of a destination device of the data packet (e.g., IP address 112b of device 110b from network environment 140b), a data field associated with a source port number of a network resource used by the source device to send the data packet (e.g., source port number 114a), a data field associated with a destination port number of a network resource used by the destination device to receive the data packet (e.g., destination port number 114b), a data field associated with a transport protocol of the data packet (e.g., TCP, UDP), or other data fields. In some embodiments, tuple 200 may also include a data field to identify the data packet. The data packet from which tuple 200 is generated is assigned a data packet identifier.

Facet values 204 may include a value extracted from the data packet (or copy of the data packet) corresponding to one of facet data fields 202. These facet values may correspond to facet data fields 202. For example, the facet value of the data field associated with the source IP address may be 163.193.4.1/32, the facet value of the data field associated with the destination IP address may be 216.1756.102.54/32, the facet value of the data field associated with the source port number may be 12000, the facet value of the data field associated with the destination port number may be 11211, the facet value of the data field associated with the transport protocol may be UDP, and the facet value of the data field identifying the data packet from which tuple 200 is generated may be 1234. In some embodiments, traffic reception subsystem 104 may be configured to store data tuples, such as tuple 200-210, in data traffic database 160. In some embodiments, data traffic database 160 may be populated with the data packets, or copies of the data packets, which can be paired to their corresponding data structures and/or mapped to memory locations of data traffic database 160 where the corresponding data structures are stored. Tuple 210 may have a similar format as that of tuple 200, albeit some or all of the facet values included in tuple 210 may differ from the facet values included in tuple 200. For example, each tuple may be associated with a different data packet, and therefore may include a different data packet identifier. However, in normal operating conditions of network environments 140a, 140b, other facets may vary from data packet to data packet. When multiple data packets have multiple matching facet values, this can be an indication of an abnormal data traffic condition occurring, particularly if the volume, type, flow rate, or other characteristics of the data traffic flow for those data packets exhibits abnormalities. For example, a large volume of traffic (e.g., 1 GBps or more) transmitted between a same source IP address, destination IP address, source port number, destination port number, and using a same transport protocol is detected, this can indicate that an elephant flow is present. In response to determining that a possible elephant flow has been detected for a certain set of facets (i.e., the tuple associated with a generated alert), computing system 102 may be configured to perform one or more network resource usage modification rules to data packets detected by some or all of the network monitoring devices that include the same set of facets. For example, because the data packets may include the same set of facets, an additional tuple may not need to be created and/or stored because one already has been created (as it matches the tuple associated with the alert). Thus, a counter associated with the tuple may be incremented for each subsequently received data packet that has a matching tuple. This can reduce the network resource consumption for that the network environment to reduce latencies with sending or receiving other data packets, prevent security breaches to the network environments due to network vulnerabilities created due to the elephant flows, improve the ability to tolerate the elephant flows if so desired, as well as other advantages.

In some embodiments, traffic reception subsystem 104 may be configured to identify data packets including certain tuples. For example, network monitoring devices 130a, 130b may (as detailed below) receive announcements indicating tuples to query against received data traffic. Based on these announcements, traffic reception subsystem 104 may be configured to identify whether a tuple generated for a received data packet represents facets (i.e., facet values) that match any other tuples previously created for another received data packet's facet values.

In some embodiments, the computing system 102 may not directly receive data packets or copies of data packets. Instead, the computing system 102 may receive information or summarized representations of network activity regarding data packets or network packets transmitted across the network 150. For example, an edge device (e.g., a router) may connect the devices 110 to the network 150 for communication sessions across the network 150. In doing so, the edge device can receive data packets or network packets and forward or route the data packets or network packets to and/or from destination devices of the communication sessions. While routing the data packets or network packets, the edge device can update and/or maintain a record for individual tuples (e.g., a source IP address, (ii) a destination IP address, (iii) a source port number, (iv) a destination port number, and/or (v) a transport protocol of that data packet). The record can indicate characteristics for the tuples, such as a transmission rate of the packets for the tuple, a number of data packets transmitted for the tuple, a byte count of the data in the data packets of the tuple, etc. The edge device can identify data packets and update the values for each of such tuples over time. The edge device can do so for any number of tuples. The edge device can transmit identifications of the tuples and/or the characteristics determined for the tuples to the computing system 102 over time, such as in response to requests from the computing system 102, at set intervals, or pseudo-randomly. For each transmission after each time interval, the edge device can transmit data only regarding transmitted data packets during the time interval (e.g., a total count of data packets transmitted during the time interval) or after the previous transmission or an updated count of the data packets aggregating the number of data packets transmitted for a tuple during the interval or after the previous transmission with a prior count of transmitted data packets for the tuple.

The computing system 102 can receive the information for each tuple and store a record of the information. The computing system 102 can update the record for each tuple in real-time as the computing system 102 receives the information. For example, the computing system 102 can increase the packet count or byte count for a tuple each time that the computing system 102 receives an updated packet count or byte count from an edge device, such as by aggregating the number bytes or packets transmitted during an interval with a stored count of packets or bytes or by replacing a previously stored total packet count or byte count with a newly received packet count or byte count. The computing system 102 can similarly store and/or maintain records for any number of tuples and/or characteristics of communication sessions.

In some embodiments, the traffic reception subsystem 104 can determine additional information for individual tuples. For example, the traffic reception subsystem 104 can store a database including mappings of values of facets to different types of information, such as geographic information and an Autonomous System Number (ASN) of a network associated with a source or destination IP address. The traffic reception subsystem 104 can identify the values of the facets that are included in summarized representations of data packets. The traffic reception subsystem 104 can use the identified values of the facets to identify additional information for tuples representing the combinations of the facets of the data packets. For instance, the traffic reception subsystem 104 can identify a geographic identifier of a source location of a tuple by matching the source IP address with an IP address mapped to a geographic location within the database and/or identify an ASN by matching an IP address with border gateway protocol (BGP) routing information stored in the database and mapped to the IP address. The traffic reception subsystem can determine such information for individual tuples and store the information in the records for the tuples such that the information can be used to detect traffic abnormalities for the tuples.

As mentioned above, computing system 102 may include abnormal traffic subsystem 106. Abnormal traffic subsystem 106 may be configured to determine whether an abnormal data traffic condition has been satisfied. This determination may be made by abnormal traffic subsystem 106 based on the data packet or summary for a tuple received from network monitoring devices 130a, 130b. In some embodiments, abnormal traffic subsystem 106 may determine whether each data packet or summarized representation of flows for individual tuples received satisfies any of the abnormal data traffic conditions. For example, the abnormal data traffic conditions can relate to characteristics indicative of an elephant flow having been detected. As mentioned above, elephant flows are different from DDoS attacks, and therefore may not always be associated with nefarious acts. Therefore, while most DDoS attacks are mitigated by data throttling or data dropping being performed, elephant flows are available to other mitigation techniques, some of which do not result in data loss (e.g., data traffic redirection).

In some embodiments, the abnormal data traffic conditions may include a data flow condition, a packet quantity condition, a bot test condition, or other conditions, or combinations thereof. The data flow condition may be satisfied based on abnormal traffic subsystem 106 determining that a data flow rate of the data traffic is greater than or equal to a data flow threshold. In some examples, the data flow threshold may correspond to a data flow rate representative of an elephant flow, such as a data flow rate of 1 or more GBps, 10 or more GBps, 100 or more GBps, or other amounts. The packet quantity threshold condition may be satisfied based on abnormal traffic subsystem 106 determining that a number of data packets including the alert's values (e.g., the tuple) or a value included in a representation for a tuple is greater than or equal to a data packet quantity threshold (e.g., 1 or more data packets matching the tuple, 10 or more data packets matching the tuple, etc.). In one example, the abnormal traffic subsystem 106 can aggregate counts included in different summaries that the computing system 102 receives for a tuple and compare each aggregated count to the data packet quantity threshold. The abnormal traffic subsystem 106 can similarly compare any characteristic (e.g., flow rate, byte rate, byte count, etc.) for individual tuples to such thresholds to determine whether an abnormal data traffic condition is satisfied. The bot test conditions may be satisfied, for example, if abnormal traffic subsystem 106 determines that a source device and/or destination device is part of a botnet. For example, abnormal traffic subsystem 106 may output a test message to the source/destination device. If, in response to the test message, an appropriate response message is not received, or not received in an expected amount of time, then this can indicate to abnormal traffic subsystem 106 that the source/destination device is a bot. Other abnormal data traffic conditions may include data volume conditions, where a volume of data traffic having a same tuple (e.g., tuples created from the same set of facets) is greater than or equal to a data volume threshold. The abnormal data traffic conditions can include any constraints imposed on data packets matching that tuple, having the same facets (and facet values) extracted or determined from those data packets (e.g., based on various conditions, ASNs, etc.).

If abnormal traffic subsystem 106 determines that one or more of the abnormal data traffic conditions have been satisfied, abnormal traffic subsystem 106 may instruct, or otherwise cause, abnormal traffic subsystem 106 to generate an announcement. In some embodiments, abnormal traffic subsystem 106 may generate the announcement based on a determination that an abnormal data traffic condition has been satisfied. Abnormal traffic subsystem 106 may be configured to generate the announcement such that the announcement includes instructions that can be provided to one or more of the network monitoring devices (e.g., network monitoring devices 130a, 130b). In some embodiments, the announcement may be provided to computing devices coupled to the network monitoring devices or their corresponding networks, or other components (e.g., devices 110a, 110b). These instructions can include the tuple (e.g., source IP address, destination IP address, source port number, destination port number, transport protocol) of the data packet that was compared against the abnormal data traffic conditions by abnormal traffic subsystem 106. In some embodiments, abnormal traffic subsystem 106 may be configured to select, retrieve, and/or incorporate one or more network resource usage modification rules to the announcement. Abnormal traffic subsystem 106 may select the network resource usage modification rules based on the abnormal data traffic condition or conditions that have been satisfied. As an example, a network resource usage modification rule identified by abnormal traffic subsystem 106 to transmit (i.e., propagate) to network monitoring devices 130a, 130b, may include instructions for the network monitoring devices to redirect subsequently received data packets matching the alert's values (e.g., the tuple) to one or more computing devices, computing systems, and the like, instead of their intended destination. For example, abnormal traffic subsystem 106 may be configured to redirect data packets including the same facets to an edge server network 120 based on a tuple (e.g., tuple 200) being created that matches a tuple associated with an announced alert. Edge server network 120 may include one or more network resource devices 122. Network resource devices 122 may include routers, network switches, or other devices that facilitate transmission of data packets. In some embodiments, network resource devices 122 may be the same or similar to devices 110a, 110b and/or network monitoring devices 130a, 130b (e.g., a router including a tap to monitor data traffic). Redirecting the potential elephant flow data traffic to edge server network 120, instead of the intended network environment (e.g., network environment 140b), enables computing system 102 to implement network usage modification rules that solve the technical problems associated with elephant flows. In particular, the techniques described herein enable data packets matching the alert's values (e.g., the tuple) to be analyzed securely without risk of harming devices within the destination device's network. Furthermore, redirecting these data packets reduces data traffic and network resource consumption by diverting large volume traffic flow specific to the tuple to other network resources, thereby preventing data latency and data loss while increasing data security for other aspects of the remaining data traffic.

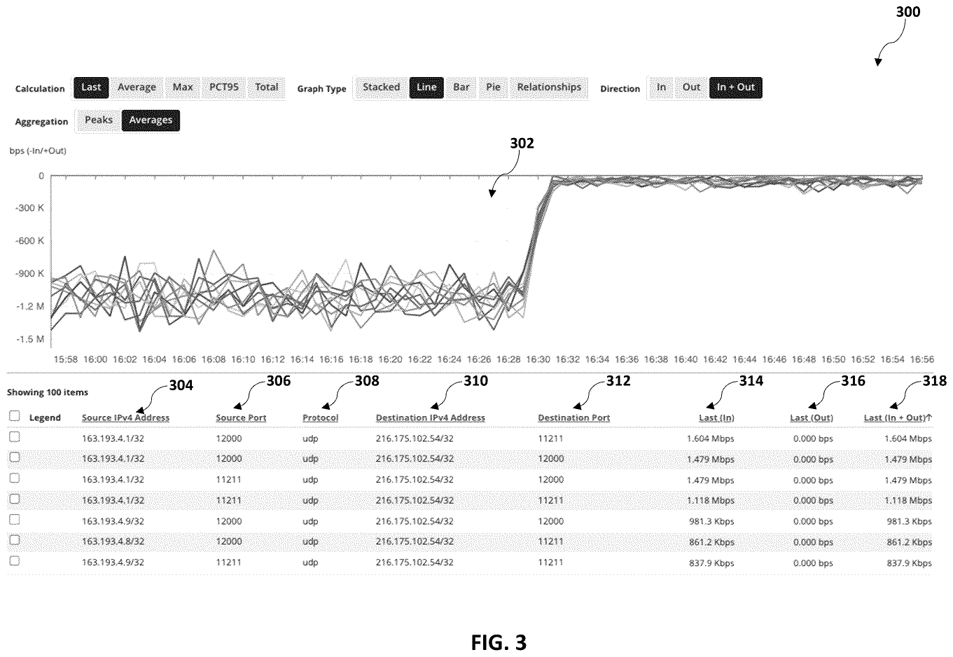

In some embodiments, suspected elephant flow data traffic can be presented to users via a graphical user interface presented on a client device 170. Users seeking to detect elephant flows, adjust network settings based on the detected elephant flows, or monitor possible or determined elephant flows can view the graphical user interface for these inquiries. As an example, with reference to FIG. 3, a graphical user interface (GUI) 300 is illustrated, which may be rendered by a display screen coupled to, or in communication with, client device 170. GUI 300 may include a plot 302 including traces of various data traffic for tuples being monitored. Plot 302 may depict real-time data traffic. For example, plot 302 may be updated at a predefined cadence (e.g., every second, every minute, every 5 minutes, every hour, etc.). At each interval, new data packets detected by the network monitoring devices can be identified, their facets and facet values extracted, tuples generated representing the facets and their facet values, and their traffic monitored (or included in the monitoring of an existing tuple). Each trace depicted in GUI 300 may have an associated entry in a table also indicating characteristics of the data flow being displayed in plot 302. For example, GUI 300 may include source IP addresses 304, source port numbers 306, transport protocols 308, destination IP addresses 310, destination port numbers 312, inbound data traffic rates 314, outbound data traffic rates 316, net data throughputs 318, or other information. In some embodiments, users can select specific tuples to monitor using GUI 300. Users can also select specific tuples to stop monitoring, as well as other actions that can be performed to data packets included in data traffic having the tuple.

While certain components of system 100 are depicted as a single instance of that component, this is not to imply that additional instances of that component may be included within system 100. For example, additional client devices may be included in system 100 in addition to or instead of client device 170. Similarly, while certain components of system 100 are depicted as multiple instances of that component, this is not to imply that a single instance of that component can be included in system 100. For example, while network environment 140a includes devices 110a, in some embodiments, network environment 140a may include a single device 110a.

Client device 170 may be an example of a user equipment (UE) or another device that can access network 150. Client device 170 can communicate with computing system 102, edge server network 120, network environments 140a, 140b, or other systems, servers, or devices, to access a service (e.g., a website, an application, etc.) or another feature.

Computing system 102, devices 110a, 110b, edge server network 120, network resource devices 122, network monitoring devices 130a, 130b, client device 170, or other components of system 100, can include or utilize at least one processing unit or other logic device such as programmable logic array engine, or module configured to communicate with one another or other resources or databases. The components of computing system 102, devices 110a, 110b, edge server network 120, network resource devices 122, network monitoring devices 130a, 130b, client device 170 can be separate components or a single component. In some embodiments, computing system 102 may be an intermediary device between client device 170 and other devices. In some embodiments, computing system 102 may be or include an external device (e.g., a security device, a monitoring device, etc.). In some embodiments, computing system 102, devices 110a, 110b, edge server network 120, network resource devices 122, network monitoring devices 130a, 130b, client device 170, or any combination thereof, may share at least some components or be the same device. The system 100 and its components can include hardware elements, such as one or more processors, logic devices, or circuits.

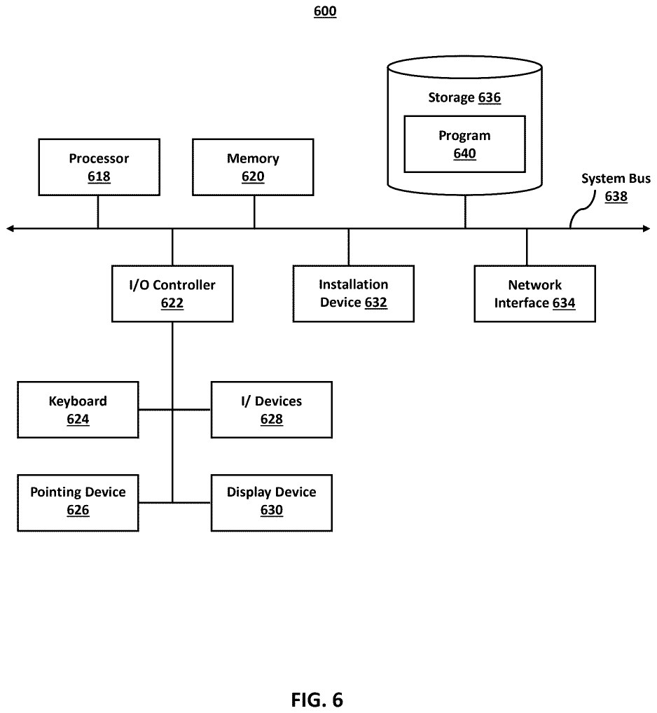

Computing system 102, devices 110a, 110b, edge server network 120, network resource devices 122, network monitoring devices 130a, 130b, client device 170 can include or execute on one or more processors or computing devices (e.g., computing device 600 depicted in FIG. 6) and/or communicate via network 150. Network 150 can include computer networks such as the Internet, local, wide, metro, or other area networks, intranets, satellite networks, and other communication networks such as voice or data mobile telephone networks. Via network 150, client device 170 can access information resources such as web pages, web sites, domain names, or uniform resource locators that can be presented, output, rendered, or displayed on at least one computing device (e.g., client device 170), such as a laptop, desktop, tablet, personal digital assistant, smart phone, portable computers, or speaker. For example, via network 150, client device 170 can communicate with one or more service providers, network monitoring devices, databases, or computing systems, for data.

Network 150 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. Network 150 may include a wireless link, such as an infrared channel or satellite band. The topology of the network 150 may include a bus, star, or ring network topology. Network 150 may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”), universal mobile telecommunications system (“UMTS”), 3G, 4G, long term evolution wireless broadband communication (“LTE”), 5G, etc. Different types of data may be transmitted via different protocols, or the same types of data may be transmitted via different protocols. In some embodiments, network 150 may be or include a self-organizing network that implements a machine learning model to automatically adjust connections and configurations of network elements of network 150 to optimize network connections (e.g., minimize latency, reduce dropped calls, increase data rate, increase quality of service, etc.).

Network 150 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods e.g., FDMA, TDMA, CDMA, or SDMA. In some embodiments, different types of data can be transmitted via different links and standards. In other embodiments, the same types of data can be transmitted via different links and standards.

Network 150 can be any type and/or form of network. The geographical scope of network 150 can vary widely and network 150 can be a body area network (BAN), a personal area network (PAN), a local-area network (LAN), e.g., Intranet, a metropolitan area network (MAN), a wide area network (WAN), or the Internet. The topology of network 150 can be of any form and can include, e.g., any of the following: point-to-point, bus, star, ring, mesh, or tree. Network 150 can be an overlay network which is virtual and sits on top of one or more layers of other network 150. Network 150 can be of any such network topology as known to those ordinarily skilled in the art capable of supporting the operations described herein. Network 150 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. Network 150 can be a type of a broadcast network, a telecommunications network, a data communication network, or a computer network.

Client device 170 can establish communication sessions with and receive data from one or more service provider devices. In some embodiments, devices 110a, 110b may include one or more service provider devices. For example, a user associated with client device 170 may request a service from a service provider device from a network environment (e.g., network environment 140a, 140b). Responsive to the request, the service provider may send requested data to client device 170 in a communication session. The requested data may be communicated between client device 170 and the service provider via a plurality of data packets. Network elements within system 100 may be configured to facilitate the transmission of data packets and, therefore, communication between client device 170 and the service providers. Data packets may be routed to different network elements within system 100. Data packets may be distributed among different network elements (and different clusters) to prevent uneven load distribution. For example, a probe may be configured to monitor multiple network elements. When data packets are evenly or near-evenly distributed among network elements, individual probes may be prevented from being overwhelmed with data packets (e.g., each probe in system 100 analyzes a generally similar number of data packets).

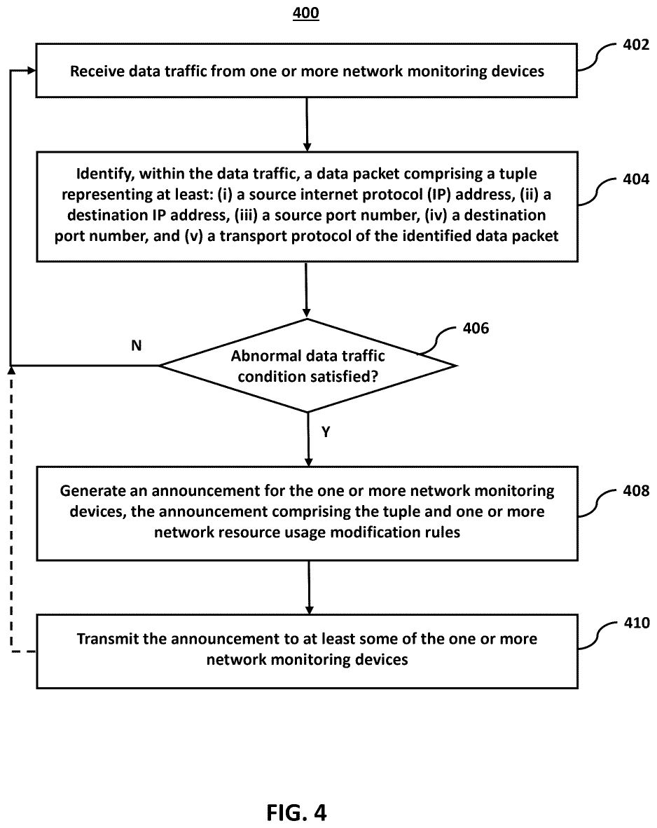

FIG. 4 is an illustration of a flow diagram of an example process 400 for detecting and mitigation network resource consumption elephant flows, in accordance with an implementation. Process 400 can be performed by a computing system (such as, for example, computing system 102, shown and described with reference to FIG. 1). Process 400 may include more or fewer operations and the operations may be performed in any order. Performance of process 400 may enable computing system 102, or other components of a system, such as system 100, to detect elephant flows within data traffic and mitigate those elephant flows in effective manners to ensure stability and security for other components (i.e., client devices, network monitoring devices, network resources, etc.) of system 100.

At operation 402, data traffic may be received from one or more network monitoring devices. For example, network monitoring devices 130a, 130b may receive data packets, such as data packet 132, being communicated to devices 110a of network environment 140a and/or devices 110b of network environment 140b. In some embodiments, the data traffic may include data traffic inbound to a central server network of computing devices and outbound from the central server network. For example, data packet 132 may be inbound to a device 110b of network environment 140b from a device 110a of network environment 140a.

In some embodiments, representative summaries of data traffic can be received from one or more edge devices. For instance, instead of identifying data packets directly, the computing system can receive summaries of transmitted traffic from edge devices that route the network traffic. The summaries can include packet counts or byte counts of network traffic that the edge devices route and/or identify tuples of the network traffic that correspond to the packet counts or byte counts.

In some embodiments, data traffic detected by network monitoring devices 130a, 130b may be forwarded to computing system 102 for analysis. In some examples, copies of the data traffic (i.e., copies of the data packets) may be provided to computing system 102 by network monitoring devices 130a, 130b. For example, network monitoring devices 130a, 130b may provide the data packets, or copies of the data packets, to traffic reception subsystem 104 of computing system 102 in real-time (i.e., within a predefined amount of time of being detected) or in batches at predefined cadences (e.g., every second, every 5 seconds, every 10 seconds, every minute, every hour, etc.). Furthermore, in some cases, the data traffic (i.e., each data packet and/or copy thereof) can continually be received from network monitoring devices 130a, 130b.

At operation 404, a tuple may be identified from the data traffic (e.g., from the summarized representations of the data traffic). The tuple can include or represent a set of facets. For example, the tuple may represent facets including (i) a source internet protocol (IP) address, (ii) a destination IP address, (iii) a source port number, (iv) a destination port number, (v) a transport protocol of the identified data packet, or other facets.

In some embodiments, traffic reception subsystem 104 of computing system 102 may be configured to receive, from network monitoring devices 130a, 130b, the data traffic. The data traffic, as mentioned above, may include a stream of data packets. Each data packet may output from a source device (e.g., one of devices 110a of network environment 140a) and is directed toward a destination device (e.g., one of devices 110b of network environment 140b). Traffic reception subsystem 104 may be configured to receive tuple information associated with such data packets from edge devices that route the network traffic. For example, traffic reception subsystem 104 may extract tuple information associated with data packet 132. The tuple information may include facet values for each facet described by a data packet. For example, the tuple information may include facets and facet values. In some embodiments, traffic reception subsystem 104 may generate tuples storing the facets and facet values represented by the tuple information. For example, tuple 200 of FIG. 2 may include facet data fields 202, including (i) a source IP address, (ii) a destination IP address, (iii) a source port number, (iv) a destination port number, and (v) a transport protocol of that data packet. Tuple 200 may also include facet values populated based on the extracted tuple information from the data packet. In some embodiments, traffic reception subsystem 104 may provide the data packet, the tuple, and/or other information, to data traffic database 160. Therefore, the tuple (e.g., the facets and their corresponding facet values) may be generated based on the extracted tuple information. In other words, tuple 200 can be used to represent the extracted tuple information of a data packet by various components of computing system 102 during analysis for abnormal data traffic conditions.

In some embodiments, (i) the source IP address comprises an IP address of a source device from which the identified data packet is output, (ii) the destination IP address comprises an IP address of a destination device towards which the identified data packet is directed, (iii) the source port number of a network service of the source device to process the identified data packet, (iv) the destination port number of a network service of the destination device to process the identified data packet, and (v) the transport protocol of the identified data packet. For example, data packet 132 may include a header storing the tuple information, such as IP address 112a (e.g., source IP address), IP address 112b (e.g., destination IP address), port number 114a (e.g., source port number), port number 114b (e.g., destination port number), and a transport protocol (e.g., TCP, UDP).

In some embodiments, the tuple represents a set of facets describing the identified data packet. For example, the set of facets may include (i) the source internet protocol (IP) address, (ii) the destination IP address, (iii) the source port number, (iv) the destination port number, and (v) the transport protocol of the identified data packet.

In some cases, computing system 102 can use the values of the set of facets for a data packet to identify additional information. For instance, computing system 102 can compare such values to a database to retrieve or identify a source geographic identifier of a source location of the identified data packet, a destination geographic identifier of a destination location of the identified data packet, an Autonomous System Number (ASN) associated with a central server network (e.g., network environment 140a, 140b) of computing devices with which the data traffic is inbound or outbound, or other features.

In some embodiments, identifying the tuple may include traffic reception subsystem 104 determining previously identified tuples. The previously identified tuples may also be analyzed to determine whether any network resource usage modification rules associated therewith. In some examples, traffic reception subsystem 104 may determine whether any previously identified tuples match a tuple being analyzed. Traffic reception subsystem 104 may detect a match between the tuple and the previously identified tuples. In some embodiments, each unique tuple may be hashed, and the hashes stored in data traffic database 160. This can reduce storage needs by storing the hash of the tuple instead of the tuple, the data packet, or both.

At operation 406, a determination may be made as to whether one or more abnormal data traffic conditions have been satisfied. In some embodiments, determining that the abnormal data traffic condition has been satisfied may include abnormal traffic subsystem 106 determining, based on the identified data packet and the previously identified tuples, a number of tuples identified having the same tuple (i.e., same set of facets having the same facet values). As described in greater detail below, abnormal traffic subsystem 106 may determine that the number of tuples is greater than or equal a data packet quantity threshold, a data flow threshold, or other abnormal data traffic conditions, or combinations thereof.

If, at operation 406, it is determined that, based on the identified data packet, the abnormal data traffic condition has not been satisfied, then process 400 may return to operation 402. At operation 402, data traffic (including data packets and/or copies of those data packets) may continue to be received, and subsequently analyzed, by computing system 102. In some embodiments, satisfying the abnormal data traffic condition may include satisfying a specific condition or set of conditions. In some embodiments, satisfying the abnormal data traffic condition may include satisfying any of the possible abnormal data traffic conditions. If, however, at operation 406, it is determined that, based on the identified data packet, one or more of the abnormal data traffic conditions have been satisfied, process 400 may proceed to operation 408.

In some embodiments, determining that the abnormal data traffic condition has been satisfied may include abnormal traffic subsystem 106 determining a flow rate of a portion of the data traffic comprising data packets including the tuple. For example, abnormal traffic subsystem 106 may determine each data packet that has been detected including the same tuple (i.e., the same set of facets and facet values, such as source IP address, destination IP address, source port number, destination port number, transport protocol, etc.). Abnormal traffic subsystem 106 may aggregate the data packets to determine a flow rate of the data traffic, which can also be referred to as a sub-flow of the data traffic, having the same tuple. Using this data flow rate, which indicates the total data traffic composed of data packets having the same source IP address, same destination IP address, same source port number, same destination port number, and same transport protocol. In some embodiments, abnormal traffic subsystem 106 may determine that the data flow condition has been satisfied based on a determination that the flow rate is greater than or equal to a data flow threshold. The data flow threshold may correspond to a data flow rate typically seen with other elephant flows (e.g., 1 GBps or more, 10 GBps or more, 100 GBps or more, etc.). In some embodiments, the data flow threshold may be pre-defined and/or may be adjustable. For example, raising the data flow threshold may result in fewer candidate elephant flows being detected, whereas lowering the data flow threshold may result in more candidate elephant flows being detected. Therefore, historical data flow rates associated with previously identified elephant flows may be used, in some cases, as an initial approximation for the data flow threshold. In some embodiments, one or more machine learning models may be trained to determine the data flow threshold.

In some embodiments, determining that the abnormal data traffic condition has been satisfied may include abnormal traffic subsystem 106 transmitting a bot test to the source device associated with the source IP address (e.g., IP address 112a for device 110a) and the destination IP address (e.g., IP address 112b for device 110b). Abnormal traffic subsystem 106 may determine a source response to the bot test from the source device located at the source IP address and a destination response to the bot test from the destination device located at the destination IP address. Abnormal traffic subsystem 106 may select the network resource usage modification rules based on the source response and the destination response. For example, if a source response to the bot test provided to the source device returns a message consistent with a bot (remotely operated computing device or system of devices) or fails to return a message within a predefined amount of time (e.g., less than 5 seconds, less than 15 seconds, less than 30 seconds, etc.), then this can indicate that the source device being a bot or part of a bot net. Abnormal traffic subsystem 106 may select one or more network resource usage modification rules based on whether the bot net test is passed.

At operation 408, an announcement for the network monitoring devices may be generated. In some embodiments, the announcement may include the tuple (e.g., the source IP address, the destination IP address, the source port number, the destination port number, the transport protocol, etc.) and one or more network resource usage modification rules. The network resource usage modification rules may be applied by the network monitoring devices to data packets received subsequent to the announcement.

In some embodiments, abnormal traffic subsystem 106 may be configured to select the network resource usage modification rules based on the abnormal data traffic condition that has been satisfied. For example, as mentioned above, the data traffic can include data traffic inbound to a central server network of computing devices (e.g., network environment 140a or network environment 140b) and outbound from the central server network. In some embodiments, abnormal traffic subsystem 106 may be configured to select a network resource usage modification rule based on the data traffic being inbound to and outbound from the central server network. For example, the network resource usage modification rule selected may include an instruction to re-direct subsequently received data packets comprising the tuple to one or more edge server networks, such as, for example, edge server network 120.

In some examples, where the identified data packet is a first data packet, traffic reception subsystem 104 may be configured to identify, subsequent to the announcement being transmitted, for example via abnormal traffic subsystem 106, to the at least some of the one or more network monitoring devices, a second data packet comprising the tuple. For example, subsequent to receiving the announce, network monitoring device 130a may detect a data packet the same facets and facets values as the facets included in a tuple being monitored for possible elephant flows. In this example, network monitoring device 130a may send the second data packet and/or a copy of the second data packet, to traffic reception subsystem 104. Traffic reception subsystem 104 may generate a tuple including facet data fields populated with facet values determined from the tuple information extracted from the second data packet. In some embodiments, traffic reception subsystem 104 may, prior to generating the tuple representing the second data packet, or subsequent to determining that the tuple representing the second data packet matches the tuple of a previously received data packet (e.g., a first data packet), increment a counter associated with the tuple. For example, each time a data packet is received, and tuple created including the same set of facets having the same set of facet values, a counter can be incremented.

Abnormal traffic subsystem 106 may determine, based on the identified second data packet, whether the abnormal data traffic condition, or conditions, previously satisfied by the first data packet, also fails to be satisfied. If abnormal traffic subsystem 106 determines that the same abnormal data traffic condition(s) as before are satisfied, no changes may be made to the network resource usage modification rules being applied to data packets including the same tuple (i.e., same facets, same facet values). In some embodiments, if one or more of the abnormal traffic conditions that were previously satisfied no longer are satisfied, for instance based on receipt of the second data packet, then abnormal traffic subsystem 106 may adjust the network resource usage modification rules being applied to data packets including that same tuple. For example, a new network resource usage modification rule may be selected based on a new abnormal traffic condition or set of conditions being satisfied. As another example, a previously applied network resource usage modification rule may no longer be applied by the network monitoring devices (e.g., network monitoring devices 130a, 130b). In some embodiments, one or more network resource usage modification rules may no longer be applied to data packets matching the tuple if a predefined amount of time has elapsed since the network resource usage modification rules were applied (e.g., more than 10 minutes, more than 1 hour, more than 1 day, etc.).

In some embodiments, abnormal traffic subsystem 106 may be configured to generate an updated announcement. The updated announcement may be for the at least some of the more network monitoring devices (e.g., network environment 140a and/or 140b). The updated announcement may include an instruction to re-direct the data traffic to the central server network instead of the edge server networks (e.g., edge server network 120). For example, based on the abnormal data traffic conditions no longer being satisfied, abnormal traffic subsystem 106 may generate instructions to allow data packets matching the tuple to be transmitted to devices 110b of network environment 140b. In some embodiments, abnormal traffic subsystem 106 may be configured to transmit the updated announcement to the at least some of the one or more network monitoring devices.

In some examples, where the identified data packet is a first data packet, traffic reception subsystem 104 may be configured to identify, subsequent to the announcement being transmitted, for example via abnormal traffic subsystem 106, to the at least some of the one or more network monitoring devices, a second data packet comprising the tuple. Abnormal traffic subsystem 106 may be configured to determine, based on the identified second data packet, that the abnormal data traffic condition remains satisfied. In some embodiments, abnormal traffic subsystem 106 may be configured to generate an updated announcement for the at least some of the network monitoring devices (e.g., network monitoring devices 130a, 130b). The updated announcement may include the tuple and a network resource usage modification rule to apply to future data packets including the tuple. In some embodiments, abnormal traffic subsystem 106 may be configured to transmit the updated announcement to the network monitoring devices to execute the network resource usage modification rule.

In some embodiments, the updated announcement may be generated based on the second data packet being received including the sample tuple being monitored for possible elephant flows. The updated announcement may also be generated based on a predefined amount of time elapsing since the data flow associated with data packets including the tuple. For example, after one or more of the abnormal traffic conditions have been satisfied for more than a threshold amount of time (e.g., 1 or more minutes, 10 or more minutes, 1 or more hours, 1 or more days, etc.), the updated announcement may be generated. In some embodiments, the updated announcement may include an updated or different network resource usage modification rule to be applied to data packets subsequently received by network monitoring devices 130a, 130b (or others in the network). For example, the updated announcement may include an instruction to rate limit or block subsequently received data packets. For example, instead of re-directing the data packets matching the tuple to edge server network 120, computing system 102 can limit the number of data packets that are allowed to be transmitted from the source device to the destination device using the same tuple. In some examples, computing system 102 may, alternatively, block/drop data traffic detected to include the same tuple subsequent to receipt of the updated announcement.

At operation 410, the announcement may be transmitted to at least some of the one or more network monitoring devices. For example, abnormal traffic subsystem 106 may be configured to transmit the announcement to network monitoring devices 130a, 130b. In some embodiments, transmitting the announcement to the network monitoring devices may include abnormal traffic subsystem 106 propagating the announcement to the at least some of the one or more network monitoring devices (e.g., network monitoring devices 130a, 130b). The announcement may include the tuple and the network resource usage modification rules.

In some embodiments, computing system 102 may be configured to generate user interface data to render a user interface on a client device. For example, user interface data may be generated representing graphical user interface 300 of FIG. 3. As seen in FIG. 3, graphical user interface 300 may display the tuples being monitored. Graphical user interface 300 may also display a number of data packets that have been identified including the tuple, a data flow rate of the data packets that have been identified including the tuple, or other information regarding the tuples being monitored for elephant flows.

In some embodiments, process 400 may return to operation 402 after operation 410. For example, after the announcement has been transmitted to network monitoring devices 130a, 130b, computing system 102 may continue to receive data traffic. That data traffic may be monitored, using the network monitoring devices and computing system 102, to determine whether any subsequently received data packets include the same set of facets and facet values (e.g., the tuple) as a tuple being monitored for possible elephant flows.

In some embodiments, process 400 may be executed continually. For example, after each iteration, process 400 restarts. In some embodiments, process 400 may execute continually for a finite amount of times or for a finite number of iterations. Still further, process 400 may execute at a predefined cadence (e.g., every minute, every five minutes, etc.).

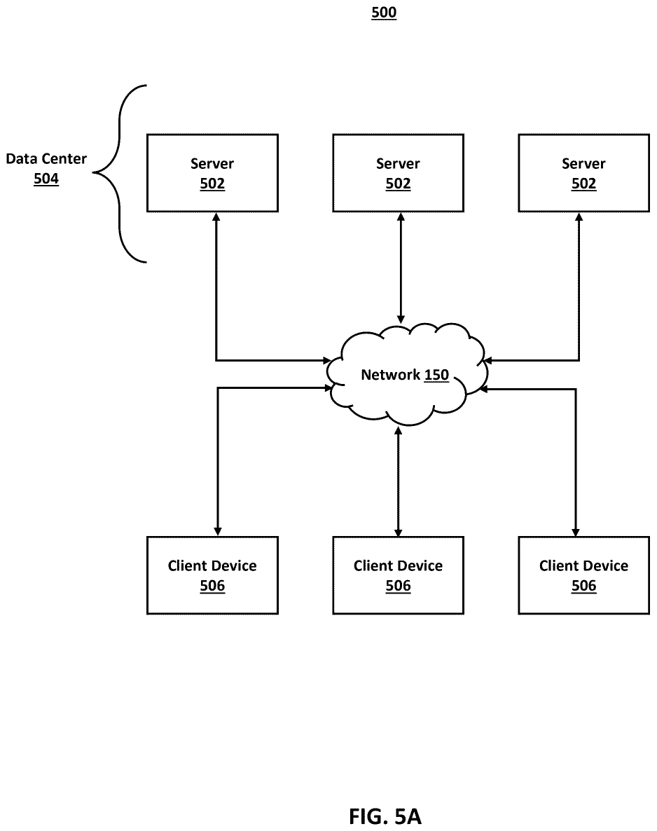

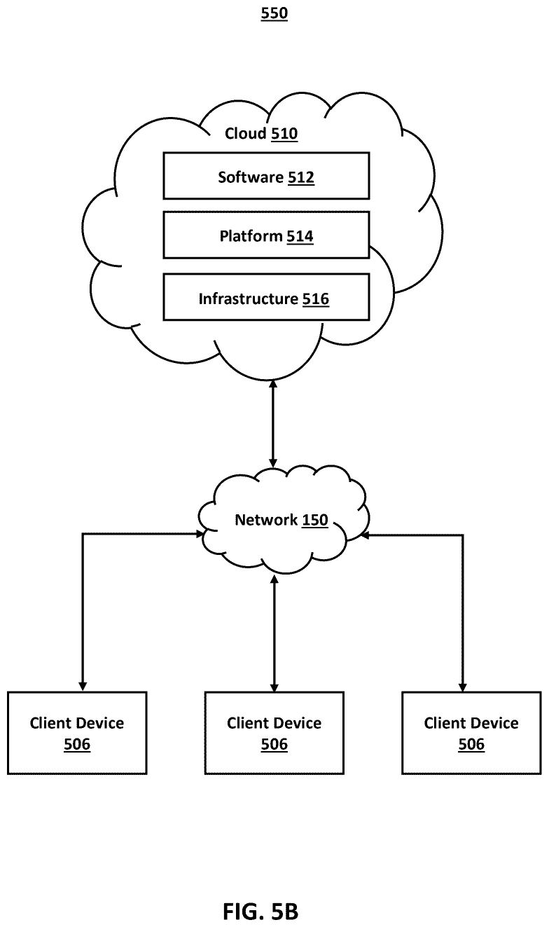

FIG. 5A depicts an example network environment 500 that can be used in connection with the methods and systems described herein, in accordance with an implementation. In brief overview, network environment 500 includes one or more client devices 506 (also generally referred to as clients, client node, client machines, client computers, client computing devices, endpoints, or endpoint nodes) in communication with one or more servers 502 (also generally referred to as servers, nodes, or remote machine) via one or more network 150. In some embodiments, client device 506 has the capacity to function as both a client node seeking access to resources provided by a server and as a server providing access to hosted resources for other client devices 506. In some embodiments, client device 506 may be the same or similar to client device 170 of FIG. 1, and the previous descriptions may apply. Furthermore, one or more of servers 502 and/or data center 504 may be the same or similar to computing system 102 of FIG. 1 and/or edge server network 120.

Although FIG. 5A shows network 150 between client device 506 and servers 502, client devices 506 and servers 502 can be on the same network 150. In some embodiments, there are multiple networks 150 between client devices 506 and servers 502. Network 150 can include multiple networks such as a private network and a public network. Network 150 can include multiple private networks.

Network environment (such as network environment 140a, 140b) can include multiple, logically grouped servers 502. The logical group of servers can be referred to as a data center 504 (or server farm or machine farm). In some embodiments, servers 502 can be geographically dispersed. Data center 504 can be administered as a single entity or different entities. Data center 504 can include multiple data centers that can be geographically dispersed. Servers 502 within each data center can be homogeneous or heterogeneous (e.g., one or more of servers 502 can operate according to one type of operating system platform (e.g., WINDOWS NT, manufactured by Microsoft Corp. of Redmond, Washington), while one or more of other servers 502 can operate on according to another type of operating system platform (e.g., Unix, Linux, or Mac OS X)). Servers 502 of each data center do not need to be physically proximate to another server 502 in the same server farm (e.g., data center 504). Thus, the group of servers 502 logically grouped as a data center 504 can be interconnected using a network. Management of data center 504 can be de-centralized. For example, one or more servers 502 can comprise components, subsystems and modules to support one or more management services for data center 504.

Server 502 can be a file server, application server, web server, proxy server, appliance, network appliance, gateway, gateway server, virtualization server, deployment server, SSL VPN server, or firewall. In embodiments, server 502 can be referred to as a remote machine or a node. Multiple nodes can be in the path between any two communicating servers.

FIG. 5B illustrates an example cloud computing environment 550, in accordance with an implementation. A cloud computing environment 550 can provide client device 506 with one or more resources provided by a network environment. Cloud computing environment 550 can include one or more client device 506, in communication with cloud 510 over network 150. Client devices 506 can include, for example, thick clients, thin clients, and zero clients. A thick client can provide at least some functionality even when disconnected from cloud 510 or servers 502. A thin client or a zero client can depend on the connection to cloud 510 or server 502 to provide functionality. A zero client can depend on cloud 510 or other network 150 or servers 502 to retrieve operating system data for the client device. Cloud 510 can include back-end platforms, for example, servers 502, storage, server farms or data centers.

Cloud 510 can be public, private, or hybrid. Public clouds can include public servers 502 that are maintained by third parties to client devices 506 or the owners of the clients. Servers 502 can be located off-site in remote geographical locations as disclosed above or otherwise. Public clouds can be connected to servers 502 over a public network. Private clouds can include private servers 502 that are physically maintained by client devices 506 or owners of clients. Private clouds can be connected to servers 502 over a private network. Hybrid clouds can include both the private and public network 150 and servers 502.

Cloud 510 can also include a cloud-based delivery, such as, for example, Software as a Service (Saas) 512, Platform as a Service (PaaS) 514, and the Infrastructure as a Service (IaaS) 516. IaaS 516 can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, for example, storage, networking, servers or virtualization, as well as additional resources such as, for example, the operating system, middleware, or runtime resources. SaaS providers can offer the resources that PaaS provides, including storage, networking, servers, virtualization, operating system, middleware, or runtime resources. In some embodiments, SaaS providers can offer additional resources including, for example, data and application resources.

Client devices 506 can access IaaS resources, SaaS resources, or PaaS resources. In embodiments, access to IaaS 516, PaaS 514, or SaaS 512 resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

Client device 506 and server 502 can be deployed as and/or executed on any type and form of computing device, e.g., a computer, network device or appliance capable of communicating on any type and form of network and performing the operations described herein.

FIG. 6 depicts block diagrams of a computing device 600 useful for practicing an embodiment of a client device, such as client device 170 of FIG. 1 or client device 506 of FIGS. 5A-5B, or a server or computing system, such as computing system 102 of FIG. 1 or sever(s) 502 of FIGS. 5A-5B, in accordance with an implementation. As shown in FIG. 6, each computing device 600 can include a central processing unit 618, and memory 620. As shown in FIG. 6, a computing device 600 can include one or more of a storage 636, an installation device 632, a network interface 634, an I/O controller 622, a display device 630, a keyboard 624 or a pointing device 626 (e.g., a mouse). Storage 636 can include, without limitation, a program 640, such as an operating system, software, or software associated with system 100.

Central processing unit 618 is any logic circuitry that responds to and processes instructions fetched from memory 620. Central processing unit 618 can be provided by a microprocessor unit, e.g.: those manufactured by Intel Corporation of Mountain View, California. Computing device 600 can be based on any of these processors, or any other processor capable of operating as described herein. Central processing unit 618 can utilize instruction level parallelism, thread level parallelism, different levels of cache, and multi-core processors. A multi-core processor can include two or more processing units on a single computing component.

Memory 620 can include one or more memory chips capable of storing data and allowing any storage location to be directly accessed by central processing unit 618. In some examples, central processing unit 618 may be a microprocessor. Memory 620 can be volatile and faster than storage 636. Memory 620 can be Dynamic random-access memory (DRAM) or any variants, including static random access memory (SRAM). Memory 620 or storage 636 can be non-volatile, for example, non-volatile read access memory (NVRAM). Memory 620 can be based on any type of memory chip, or any other available memory chips. In the example depicted in FIG. 6, central processing unit 618 can communicate with memory 620 via a system bus 638.

A wide variety of I/O devices 628 can be present in computing device 600. Input devices 628 can include keyboards, mice, trackpads, trackballs, touchpads, touch mice, multi-touch touchpads and touch mice, microphones, multi-array microphones, drawing tablets, cameras, or other sensors. Output devices can include video displays, graphical displays, speakers, headphones, or printers.

I/O devices 628 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 628, display devices 630 or group of devices can be augmented reality devices. The I/O devices can be controlled by an I/O controller 622 as shown in FIG. 6. I/O controller 622 can control one or more I/O devices, such as, for example, a keyboard 624 and a pointing device 626 (e.g., a mouse, optical pen). Furthermore, an I/O device can also provide storage and/or an installation device 632 for computing device 600. In embodiments, computing device 600 can provide USB connections (not shown) to receive handheld USB storage devices. In embodiments, an I/O device 628 can be a bridge between system bus 638 and an external communication bus (e.g., a USB bus, a SCSI bus, a FireWire bus, an Ethernet bus, a Gigabit Ethernet bus, a Fibre Channel bus, or a Thunderbolt bus).

In embodiments, display devices 630 can be connected to I/O controller 622. Display devices can include, for example, liquid crystal displays (LCD), electronic papers (e-ink) displays, flexile displays, light emitting diode displays (LED), or other types of displays. In some embodiments, display devices 630 or the corresponding I/O controllers 622 can be controlled through or have hardware support for OPENGL or DIRECTX API or other graphics libraries. Any of the I/O devices 628 and/or the I/O controller 622 can include any type and/or form of suitable hardware, software, or combination of hardware and software to support, enable or provide for the connection and use of one or more display devices 30 by computing device 600. For example, computing device 600 can include any type and/or form of video adapter, video card, driver, and/or library to interface, communicate, connect or otherwise use display devices 630. In embodiments, a video adapter can include multiple connectors to interface to multiple display devices 630.

Computing device 600 can include storage 636 (e.g., one or more hard disk drives or redundant arrays of independent disks) for storing an operating system or other related software, and for storing application software programs 40 such as any program related to the systems, methods, components, modules, elements, or functions depicted in FIG. 1. Examples of storage 636 including hard disk drive (HDD); optical drive including CD drive, DVD drive, or BLU-RAY drive; solid-state drive (SSD); USB flash drive; or any other device suitable for storing data. Storage devices 636 can include multiple volatile and non-volatile memories, including solid state hybrid drives that combine hard disks with solid state cache. Storage devices 636 can be non-volatile, mutable, or read-only. Storage devices 636 can be internal and connect to the computing device 600 via system bus 638. Storage 636 can be external and connect to the computing device 600 via an I/O device 630 that provides an external bus. Storage 636 can connect to computing device 600 via network interface 634 over network 150. Some client devices 170 may not require a non-volatile storage 636 and can be thin clients or zero client devices 170. Some storage devices 636 can be used as an installation device 632 and can be suitable for installing software and programs.

Computing device 600 can include a network interface 634 to interface to network 150 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). Computing device 600 can communicate with other computing devices via any type and/or form of gateway or tunneling protocol e.g., Secure Socket Layer (SSL) or Transport Layer Security (TLS), QUIC protocol, or the Citrix Gateway Protocol manufactured by Citrix Systems, Inc. of Ft. Lauderdale, Florida. Network interface 634 can include a built-in network adapter, network interface card, PCMCIA network card, EXPRESSCARD network card, card bus network adapter, wireless network adapter, USB network adapter, modem or any other device suitable for interfacing computing device 600 to any type of network capable of communication and performing the operations described herein.

Computing device 600 of the sort depicted in FIG. 6 can operate under the control of an operating system, which controls scheduling of tasks and access to system resources. Computing device 600 can be running any operating system configured for any type of computing device, including, for example, a desktop operating system, a mobile device operating system, a tablet operating system, or a smartphone operating system.

Computing device 600 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. Computing device 600 has sufficient processor power and memory capacity to perform the operations described herein. In some embodiments, the computing device 600 can have different processors, operating systems, and input devices consistent with the device.

In embodiments, the status of one or more machines in network system 100 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 600 in response to central processing unit 618 executing an arrangement of instructions contained in memory 620. Such instructions can be read into memory 620 from another computer-readable medium, such as storage 636. Execution of the arrangement of instructions contained in memory 620 causes computing device 600 to perform the illustrative processes described herein. One or more processors in a multi-processing arrangement may also be employed to execute the instructions contained in memory 620. Hard-wired circuitry can be used in place of or in combination with software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

The foregoing detailed description includes illustrative examples of various aspects and embodiments and provides an overview or framework for understanding the nature and character of the claimed aspects and embodiments. The drawings provide illustration and a further understanding of the various aspects and embodiments and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of computing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all embodiments, and the described program components can be included in a single hardware or software product.

The phraseology and terminology used herein is for the purpose of description and should not be regarded as limiting. Any references to embodiments or elements or acts of the systems and methods herein referred to in the singular may also embrace embodiments including a plurality of these elements, and any references in plural to any implementation or element or act herein may also embrace embodiments including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

The present techniques will be better understood with reference to the following enumerated embodiments:
1. A method for detecting and mitigating network resource consumption elephant flows in distributed network resources.
2. The method of embodiment 1, comprising: identifying, from information of data traffic received by one or more network monitoring devices, a tuple representing at least: (i) a source internet protocol (IP) address, (ii) a destination IP address, (iii) a source port number, (iv) a destination port number, and (v) a transport protocol of the identified tuple; determining, based on the identified tuple, that an abnormal data traffic condition has been satisfied; generating an announcement for the one or more network monitoring devices, the announcement comprising the tuple and one or more network resource usage modification rules to be applied by the one or more network monitoring devices to data packets received subsequent to the announcement; and transmitting the announcement to at least some of the one or more network monitoring devices.
3. The method of embodiment 2, wherein the announcement is generated in response to determining that the abnormal data traffic condition has been satisfied.
4. The method of any one of embodiments 2-3, further comprising: receiving, from the one or more network monitoring devices, the data traffic; and extracting, from each data packet included in the data traffic, tuple information associated with that tuple, wherein the tuple information comprises (i) a corresponding source IP address, (ii) a corresponding destination IP address, (iii) a corresponding source port number, (iv) a corresponding destination port number, and (v) a corresponding transport protocol of that data packet, wherein the tuple is generated based on the extracted tuple information.
5. The method of any one of embodiments 2-4, wherein identifying the tuple comprises: determining previously identified tuples that have network resource usage modification rules associated therewith, wherein the previously identified tuples comprise the tuple; and detecting a match between the tuple and the previously identified tuples.
6. The method of embodiment 5, wherein determining that the abnormal data traffic condition has been satisfied comprises: determining, based on the identified data packet and the previously identified tuples, a number of tuples identified comprising the tuple; and determining that the number of tuples is greater than or equal a data packet quantity threshold.
7. The method of any one of embodiments 2-6, wherein determining that the abnormal data traffic condition has been satisfied comprises: determining a flow rate of a portion of the data traffic comprising data packets including the tuple; and determining that the flow rate is greater than or equal to a data flow threshold.
8. The method of any one of embodiments 2-7, further comprising: selecting the one or more network resource usage modification rules based on the abnormal data traffic condition that has been satisfied.
9. The method of any one of embodiments 2-8, wherein transmitting the announcement to the at least some of the one or more network monitoring devices comprises: propagating the announcement to the at least some of the one or more network monitoring devices, wherein the announcement comprises the tuple and the one or more network resource usage modification rules.
10. The method of any one of embodiments 2-9, wherein (i) the source IP address comprises an IP address of a source device from which a data packet containing the identified tuple is output, (ii) the destination IP address comprises an IP address of a destination device towards which the data packet is directed, (iii) the source port number of a network service of the source device to process the data packet, (iv) the destination port number of a network service of the destination device to process the data packet, and (v) the transport protocol of the data packet.
11. The method of any one of embodiments 2-10, wherein the tuple represents a set of facets, the set of facets comprise (i) the source internet protocol (IP) address, (ii) the destination IP address, (iii) the source port number, (iv) the destination port number, and (v) the transport protocol of the identified tuple.
12. The method of embodiment 11, wherein the set of facets further comprising identifying, by comparing one or more of the set of facets with a look-up table, at least one of: a source geographic identifier of a source location of the identified data packet, a destination geographic identifier of a destination location of the identified data packet, an Autonomous System Number (ASN) associated with a central server network of computing devices with which the data traffic is inbound or outbound.
13. The method of any one of embodiments 2-12, wherein the data traffic comprises data traffic inbound to a central server network of computing devices and outbound from the central server network, the method further comprising: selecting a first network resource usage modification rule of the one or more network resource usage modification rules based on the data traffic being inbound to and outbound from the central server network, the first network resource usage modification rule comprising an instruction to re-direct subsequently received data packets comprising the tuple to one or more edge server networks.
14. The method of embodiment 13, wherein the method further comprises: identifying, subsequent to the announcement being transmitted to the at least some of the one or more network monitoring devices, a second data packet comprising the tuple; determining, based on the identified second data packet, that the abnormal data traffic condition failed to be satisfied; generating an updated announcement for the at least some of the one or more network monitoring devices, the updated announcement comprises an instruction to re-direct the data traffic to the central server network instead of the one or more edge server networks; and transmitting the updated announcement to the at least some of the one or more network monitoring devices.
15. The method of embodiment 13, wherein the method further comprises: identifying, subsequent to the announcement being transmitted to the at least some of the one or more network monitoring devices, a second data packet comprising the tuple; determining, based on the identified second data packet, that the abnormal data traffic condition remains satisfied; generating an updated announcement for the at least some of the one or more network monitoring devices, the updated announcement comprising the tuple and a network resource usage modification rule to apply to future data packets including the tuple; and transmitting the updated announcement to the at least some of the one or more network monitoring devices to rate limit or block subsequently received data packets from the data traffic including the tuple being re-directed to the one or more edge server networks.
16. The method of any one of embodiments 2-15, wherein determining that the abnormal data traffic condition has been satisfied comprises: transmitting a bot test to the source IP address and the destination IP address; and determining a source response to the bot test from the source IP address and a destination response to the bot test from the destination IP address, wherein the one or more network resource usage modification rules are selected based on the source response and the destination response.
17. The method of any one of embodiments 2-16, further comprising: generating user interface data to render a user interface on a client device, wherein the user interface displays the tuple and at least one of: a number of data packets that have been identified including the tuple or a data flow rate of the data packets that have been identified including the tuple.
18. One or more non-transitory, computer-readable media storing instructions that, when executed by a data processing apparatus, cause the data processing apparatus to perform operations comprising those of any of embodiments 1-17.
19. A system comprising: memory storing computer program instructions; and one or more processors programmed with the computer program instructions to perform operations comprising those of any of embodiments 1-17.
20. A system comprising means for performing any of embodiments 1-17.

1. A system for detecting and mitigating network resource consumption elephant flows in distributed network resources, the system comprising:
a plurality of network monitoring devices that monitor real-time data traffic inbound to a central server network of computing devices and outbound from the central server network, the real-time data traffic comprising a stream of data packets;
a computing system comprising memory storing computer program instructions and one or more processors that execute the computer program instructions configuring the one or more processors to:
receive information of the real-time data traffic from the plurality of network monitoring devices;
identify, from the information of the real-time data traffic, a five-tuple representing (i) a source internet protocol (IP) address of a source device from which a data packet containing the identified tuple is output, (ii) a destination IP address of a destination device towards which the data packet is directed, (iii) a source port number of a network service of the source device to process the data packet, (iv) a destination port number of a network service of the destination device to process the data packet, and (v) a transport protocol of the tuple;
responsive to determining, based on the identified five-tuple, that an abnormal data traffic condition has been satisfied, generate an announcement for the plurality of network monitoring devices, the announcement comprising the five-tuple and a network resource usage reduction rule to apply to future data packets including the five-tuple that are detected by any of the plurality of network monitoring devices, wherein the abnormal data traffic condition is associated with a candidate elephant flow, wherein satisfying the abnormal data traffic condition comprises (a) a number of data packets identified to include the same five-tuple being greater than or equal to a data packet quantity threshold and (b) a data flow rate of the data packets identified to include the same five-tuple being greater than or equal to a data flow rate threshold; and
propagate the announcement to the plurality of network monitoring devices, wherein the plurality of network monitoring devices direct subsequently received data packets from the real-time data traffic including the five-tuple to an edge server network of computing devices to reduce an amount of the real-time data traffic directed to and processed using the central server network.

2. The system of claim 1, wherein the data packet comprises a first data packet, the one or more processors of the computing system are further configured to:
identify a second data packet received subsequent to the announcement being propagated to the plurality of network monitoring devices based on the second data packet comprising the five-tuple;
responsive to determining, based on the identified second data packet, that the abnormal data traffic condition failed to be satisfied, generate an updated announcement for the plurality of network monitoring devices, the updated announcement comprising the five-tuple and a network resource usage restoration rule to apply to future data packets including the five-tuple; and
propagate the updated announcement to the plurality of network monitoring devices, wherein in response to receiving the updated announcement, the plurality of network monitoring devices re-direct subsequently received data packets from the real-time data traffic including the five-tuple to the central server network.

3. The system of claim 1, wherein the data packet comprises a first data packet, the one or more processors of the computing system are further configured to:
identify a second data packet received subsequent to the announcement being propagated to the plurality of network monitoring devices based on the second data packet comprising the same five-tuple;
responsive to determining, based on the identified second data packet, that the abnormal data traffic condition remains satisfied, generate an updated announcement for the plurality of network monitoring devices, the updated announcement comprising the five-tuple and a network resource usage modification rule to apply to future data packets including the five-tuple; and
propagate the updated announcement to the plurality of network monitoring devices, wherein responsive to receiving the updated announcement, the plurality of network monitoring devices are configured to rate limit or block subsequently received data packets from the real-time data traffic including the five-tuple being re-directed to the edge server network.

4. A method, implemented by one or more processors of a computing system, comprising:
identifying, from information of data traffic received by one or more network monitoring devices, a tuple representing at least: (i) a source internet protocol (IP) address, (ii) a destination IP address, (iii) a source port number, (iv) a destination port number, and (v) a transport protocol of the identified tuple;
determining, based on the identified tuple, that an abnormal data traffic condition has been satisfied; generating an announcement for the one or more network monitoring devices, the announcement comprising the tuple and one or more network resource usage modification rules to be applied by the one or more network monitoring devices to data packets received subsequent to the announcement; and
transmitting the announcement to at least some of the one or more network monitoring devices.

5. The method of claim 4, further comprising:
receiving, from the one or more network monitoring devices, the data traffic; and
extracting, from each data packet included in the data traffic, tuple information associated with that tuple, wherein the tuple information comprises (i) a corresponding source IP address, (ii) a corresponding destination IP address, (iii) a corresponding source port number, (iv) a corresponding destination port number, and (v) a corresponding transport protocol of that tuple, wherein the tuple is generated based on the extracted tuple information.

6. The method of claim 4, wherein identifying the tuple comprises:
determining previously identified tuples that have network resource usage modification rules associated therewith, wherein the previously identified tuples comprise the tuple; and
detecting a match between the tuple and the previously identified tuples.

7. The method of claim 6, wherein determining that the abnormal data traffic condition has been satisfied comprises:
determining, based on the identified tuple and the previously identified tuples, a number of tuples identified comprising the tuple; and
determining that the number of tuples is greater than or equal a data packet quantity threshold.

8. The method of claim 4, wherein determining that the abnormal data traffic condition has been satisfied comprises:
determining a flow rate of a portion of the data traffic comprising data packets including the tuple; and
determining that the flow rate is greater than or equal to a data flow threshold.

9. The method of claim 4, further comprising:
selecting the one or more network resource usage modification rules based on the abnormal data traffic condition that has been satisfied.

10. The method of claim 4, wherein transmitting the announcement to the at least some of the one or more network monitoring devices comprises:
propagating the announcement to the at least some of the one or more network monitoring devices, wherein the announcement comprises the tuple and the one or more network resource usage modification rules.

11. The method of claim 4, wherein (i) the source IP address comprises an IP address of a source device from which a data packet containing the identified tuple is output, (ii) the destination IP address comprises an IP address of a destination device towards which the identified data packet is directed, (iii) the source port number of a network service of the source device to process the data packet, (iv) the destination port number of a network service of the destination device to process the data packet, and (v) the transport protocol of the data packet.

12. The method of claim 4, wherein the tuple represents a set of facets describing the data packet, the set of facets comprise (i) the source internet protocol (IP) address, (ii) the destination IP address, (iii) the source port number, (iv) the destination port number, and (v) the transport protocol of the data packet.

13. The method of claim 12, further comprising identifying, by comparing one or more of the set of facets with a look-up table, at least one of: a source geographic identifier of a source location of the identified tuple, a destination geographic identifier of a destination location of the identified tuple, an Autonomous System Number (ASN) associated with a central server network of computing devices with which the data traffic is inbound or outbound.

14. The method of claim 4, wherein the data traffic comprises data traffic inbound to a central server network of computing devices and outbound from the central server network, the method further comprising:
selecting a first network resource usage modification rule of the one or more network resource usage modification rules based on the data traffic being inbound to and outbound from the central server network, the first network resource usage modification rule comprising an instruction to re-direct subsequently received data packets comprising the tuple to one or more edge server networks.

15. The method of claim 14, wherein the method further comprises:
identifying, subsequent to the announcement being transmitted to the at least some of the one or more network monitoring devices, a second data packet comprising the tuple;
determining, based on the identified second data packet, that the abnormal data traffic condition failed to be satisfied;
generating an updated announcement for the at least some of the one or more network monitoring devices, the updated announcement comprises an instruction to re-direct the data traffic to the central server network instead of the one or more edge server networks; and
transmitting the updated announcement to the at least some of the one or more network monitoring devices.

16. The method of claim 14, wherein the method further comprises:
identifying, subsequent to the announcement being transmitted to the at least some of the one or more network monitoring devices, a second data packet comprising the tuple;
determining, based on the identified second data packet, that the abnormal data traffic condition remains satisfied;
generating an updated announcement for the at least some of the one or more network monitoring devices, the updated announcement comprising the tuple and a network resource usage modification rule to apply to future data packets including the tuple; and
transmitting the updated announcement to the at least some of the one or more network monitoring devices to rate limit or block subsequently received data packets from the data traffic including the tuple being re-directed to the one or more edge server networks.

17. The method of claim 4, wherein determining that the abnormal data traffic condition has been satisfied comprises:
transmitting a bot test to the source IP address and the destination IP address; and
determining a source response to the bot test from the source IP address and a destination response to the bot test from the destination IP address, wherein the one or more network resource usage modification rules are selected based on the source response and the destination response.

18. The method of claim 4, further comprising:
generating user interface data to render a user interface on a client device, wherein the user interface displays the tuple and at least one of: a number of data packets that have been identified including the tuple or a data flow rate of the data packets that have been identified including the tuple.

19. One or more non-transitory computer-readable media storing computer program instructions that, when executed by one or more processors, effectuate operations comprising:
identifying, from information of data traffic, a tuple indicating at least: (i) a source internet protocol (IP) address, (ii) a destination IP address, (iii) a source port number, (iv) a destination port number, and (v) a transport protocol of the tuple;
responsive to determining, based on the identified tuple, that an abnormal data traffic condition has been satisfied, generating an announcement for a network monitoring device, the announcement comprising the tuple and a rule to be applied by the network monitoring device to data packets received subsequent to the announcement; and
transmitting the announcement to the network monitoring device.

20. The one or more non-transitory computer-readable media of claim 19, wherein the data traffic comprises data traffic inbound to and outbound from a central server network, the operations further comprising:
selecting the rule based on the data traffic being inbound to and outbound from the central server network, the rule comprising an instruction to re-direct subsequently received data packets comprising the tuple to one or more edge server networks.
